(19) United States
(12) Patent Application Publication
(10) Pub. No.: US 2009/0010819 A1
(43) Pub. Date: Jan. 8, 2009

(54) VERSATILE FLOW PATH

(75) Inventors: Mats Holmquist, Sollentuna (SE); Mats Inganas, Uppsala (SE); Gerald Jesson, Knivsta (SE); Magnus Ljungstrom, Uppsala (SE)

Correspondence Address: FULBRIGHT & JAWORSKI, LLP, 1301 MCKINNEY, SUITE 5100, HOUSTON, TX, 77010-3095, US

(73) Assignee: GYROS Patent AB, Uppsala (SE)

(21) Appl. No.: 11/815,959

(22) PCT Filed: Jan. 17, 2006
(86) PCT No.: PCT/SE06/00072

§ 371 Date: Jan. 16, 2008

Related U.S. Application Data
(63) Continuation-in-part of application No. 11/038,712, filed on Jan. 20, 2005.
(60) Provisional application No. 60/685,554, filed on May 27, 2005.
(60) Provisional application No. 60/691,820, filed on Jun. 17, 2005.

(30) Foreign Application Priority Data
Jan. 17, 2004 (SE) 05001318
Jan. 17, 2005 (SE) 0500131-8
May 27, 2005 (SE) 0501223-2
Jul. 18, 2005 (SE) 0501684-5

(51) Int. Cl. B01J 19/00

(52) U.S. Cl. 422/188

(57) ABSTRACT

A flow path comprising a reaction cavity in which there is a solid phase to which an affinity reactant I1 has been immobilized by the use of an immobilizing pair of reactive structures that comprises a) a plurality of functional equal structures RSsp on the solid phase, and b) a structure RSari on affinity reactant I1, where RSsp and RSari are mutually reactive with each other to the formation of a link structure that immobilizes affinity reactant I1 to the solid phase. The characteristic feature is that the solid phase comprises a plurality of structures that derive from RSsp but do not immobilize affinity reactant I1 to the solid phase.

### FIELD OF INVENTION

The present invention relates to a new solid phase that exposes an affinity reactant firmly attached to a solid phase that is placed in reaction cavity of a flow path. The flow path is typically a microchannel structure of a microfluidic device. The invention also relates to a method of producing the innovative solid phase. The solid phase is typically used together with a dissolved counterpart to the reactant, for instance for capturing a counterpart to exposed reactant from a liquid or for otherwise enabling interaction between the affinity reactant and its counterpart. See below.

In the context of the invention the term dissolved includes that the component at issue is a true solute or is in suspended form.

All patent publications and issued patents cited herein are incorporated in their entirety by reference. This in particular applies to US patents and patent applications and international patent applications designating the US.

### TECHNICAL BACKGROUND AND OBJECTS OF THE INVENTION

Assay devices containing flow paths with pre-packed solid phases are a desire both for the customer and the manufacturer. For the manufacturer it has been a problem to provide the same product to customers that are interested in different assays, i.e. assays that require different affinity reactants on the solid phase. One solution to this problem is presented in WO 03083108 and WO 03083109 (all Gyros AB), which among others relate to flow paths with solid phases exposing a generic affinity ligand, such as streptavidin. The customer himself then can introduce his desired affinity reactant conjugated to a generic binder, such as biotin. However there are still problems associated with tuning or balancing the binding capacity or density of the desired affinity reactant on the solid phase with the actual assay or use to be carried out. See for instance our international patent application “Bridging method” filed in parallel with this application.

In the assays referred to above there are often problems in reaching desired limits of detection, precisions (coefficient of variation, CV), dynamic ranges, signal to noise levels, recoveries, diagnostic specificities and sensitivities, etc in affinity assays. It is therefore a general desire and goal to provide the kind of assays defined above in formats that facilitate acceptable levels with respect to one, twp or more of these characteristics, e.g. a) limits of detection ≦10⁻⁶ M, such as ≦10⁻⁹ M or ≦10⁻¹² M or ≦10⁻¹³ M or ≦10⁻¹⁴ M or ≦10⁻¹⁴ M or ≦10⁻¹⁶ M, b) dynamic ranges that are more than two, three, four, five or more orders of magnitude, c) precisions (CV) within ±20%, such as within ±10% or within ±5% or within ±3%, d) recoveries ≧70% such as ≧80% or ≧90% or ≧95% or around 100% or more. Problems with these performance characteristics are more pronounced and difficult to handle the lower the sample volumes handled are, for instance reagent and/or analyte samples in the lower end of the μl range including the nl- and pl-range, e.g. ≦20 μl, such as ≦5 000 nl or ≦1 000 nl or ≦500 nl.

Plurality of a particular item, such as microchannel structures in a microfluidic device, affinity reactants or analytes etc, means that there are two or more of the item, such as three or more, four or more, five or more etc. See further below.

### FIGURES

FIGS. 2-4 represents results for a so-called bridging assay applied to the present invention. Se our international patent application “Bridging method” filed in parallel with this application.

FIG. 1. A section of the microfluidic device used in the experimental part. The section contains a subset of microchannel structures.

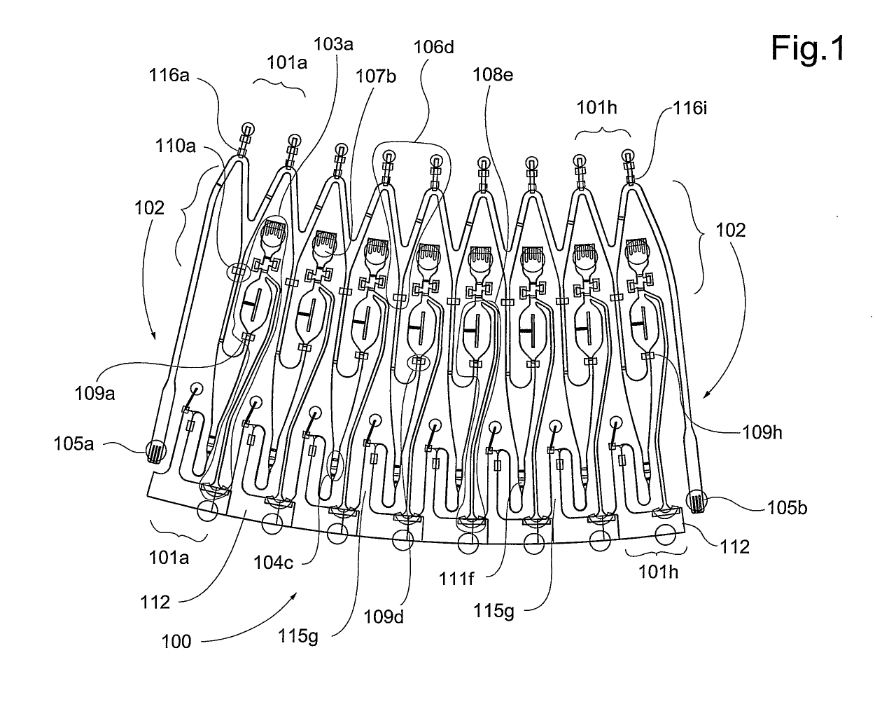

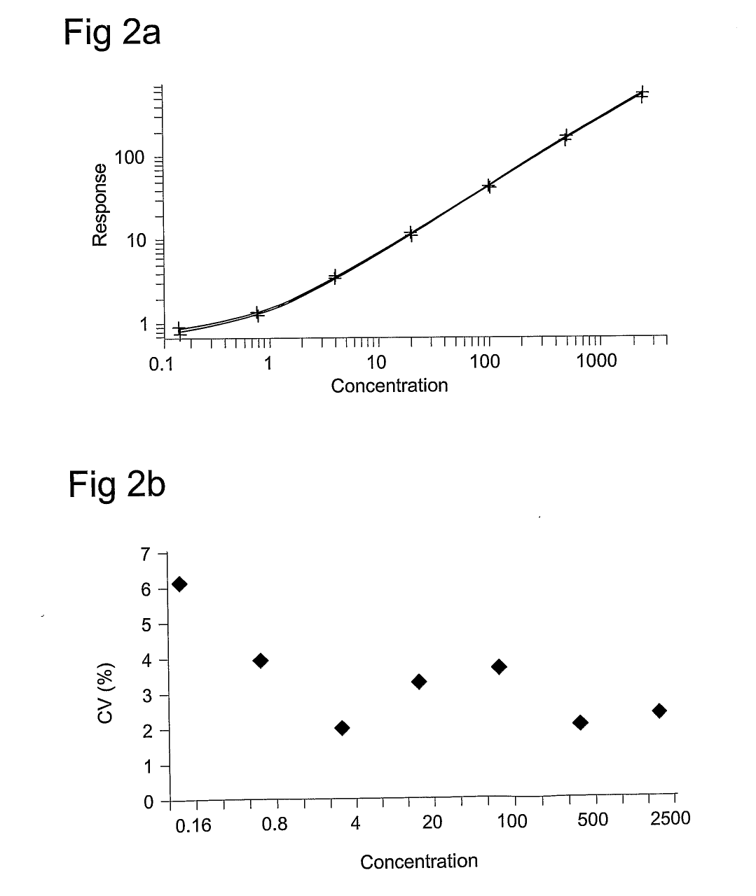

FIG. 2a-b. Measuring range and inter/intra CD assays. FIG. 2a: Rabbit α-PPV was run three times on the same day. Measuring range is over 4 orders of magnitude and both inter- and intra CD shows good reproducibility. A concentration of 100 on the x-axis corresponds to a dilution factor of 125. FIG. 2b: Plotting CVs ranging from 1.96 to 6.08.

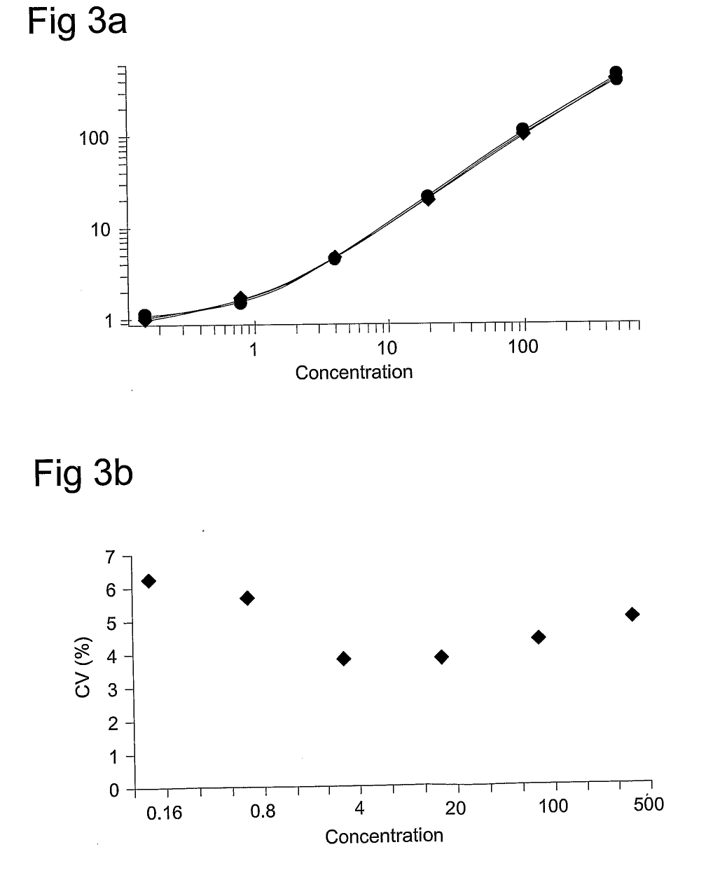

FIG. 3a-b. Reproducibility. FIG. 3a: Four standard curves from five mice pooled and serially diluted. The run was repeated four days on the same instrument. By positioning the standard curves on top of each other, good reproducibility could be demonstrated. A concentration of 100 on the x-axis corresponds to a dilution factor of 125. FIG. 3b: Variations are small with C Vs ranging from 3.74 to 6.15.

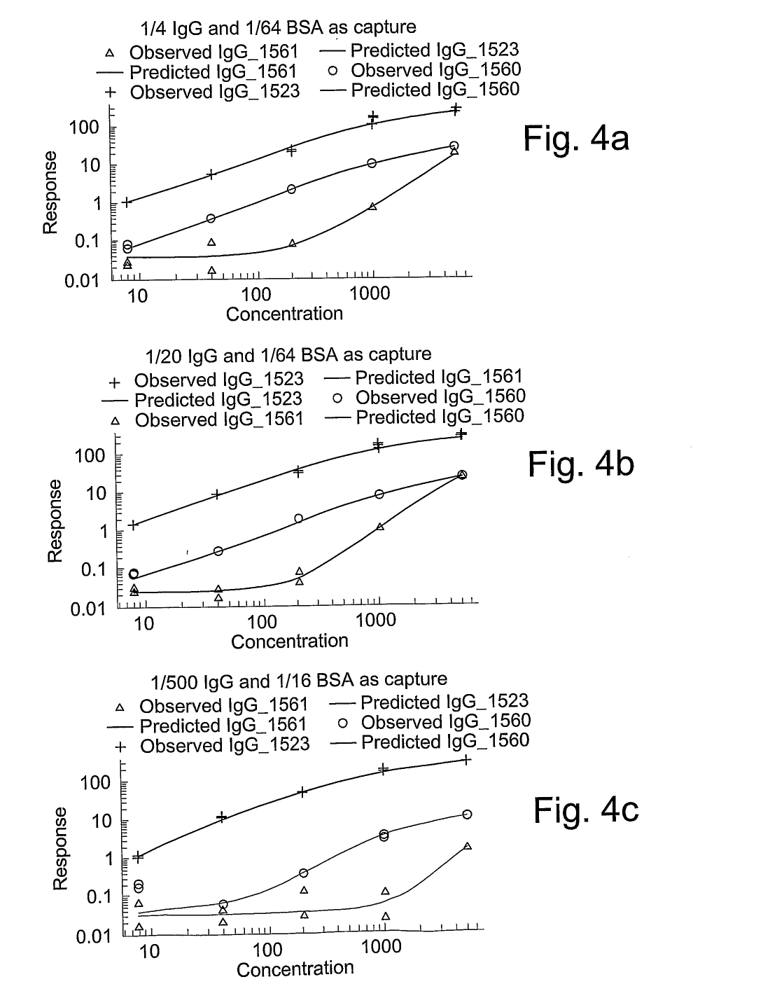

FIG. 4a-c. Standard curves for three different anti-hIgG monoclonals as analyte and various amounts/densities of hIgG as capturing antigen (affinity reactant 1) on the solid phase. Detecting antigen is fluorophor labeled hIgG (affinity reactant 2).

### THE INVENTION

We have now recognized that by performing the reaction between a solid phase that exposes RSₛₚ structures and the affinity reactant that exposes RSₐᵣ₁ under inhibition conditions the above-mentioned objects can be met. The result is very favourable and versatile solid phases that can be used in capturing of solutes from liquids passing the solid phase. Inhibition in this context means the immobilizing reaction is performed in the presence of a reactant that inhibit the reaction between RSₐᵣ₁ of the affinity reactant to be immobilized, i.e. the inhibiting reactant exposes also a structure RSₐᵣ₁ but is irrelevant for the future reaction in which the affinity reactant is to participate (i.e. the reaction between the immobilized affinity reactant and its dissolved counterpart). The use of inhibition conditions makes it simple to obtain sets of flow paths having well-defined amounts and densities of immobilized affinity reactants. The immobilizing bond is simple to create. By practising the innovative method for introducing an affinity reactant on a solid phase, the customer can easily introduce an affinity reactant adapted to his particular needs, for instance of the desired kind, capacity, density etc.

The first aspect of the invention is a flow path comprising a reaction cavity in which there is a solid phase to which an affinity reactant 1 has been immobilized by the use of an immobilizing pair of mutually reactive structures (RSₛₚ and RSₐᵣ₁) that comprises
a) a plurality of equal reactive structures RSₛₚ on the solid phase, and
b) a structure RSₐᵣ₁ on affinity reactant 1,

RSₛₚ and RSₐᵣ₁ are mutually reactive with each other in the sense that a link structure (linker) that immobilizes affinity reactant 1 to the solid phase is formed as a consequence of their reaction with each other.

The main characteristic feature of the innovative flow path is that the solid phase contains one or more equal or different structures that derive from RSₛₚ but do not link affinity reactant 1 to the solid phase. In other words the RSₛₚ-derived structures on the solid phase may be divided into different portions each of which contains a particular kind of RSₛₚ-derived structure, such as
A) a first portion for which the RSₛₚ-derived structure links/immobilizes affinity reactant 1 to the solid phase,
B) a second portion for which the RSₛₚ-derived structure links/immobilizes one or more additional affinity reactants 1², 1³ . . . 1ⁿ to the solid phase (affinity reactant 1 is affinity reactant 1¹),
C) a third portion for which the RSₛₚ-derived structure links/immobilizes a group that is irrelevant for the reaction in which an immobilized affinity reactant 1 is to participate, and
D) a fourth portion for which the RSₛₚ-derived structure is RSsp groups that are unaffected by the immobilization of reactants to the solid phase.

The RSₛₚ-derived structure of group (C) typically corresponds to an immobilized irrelevant reactant or group (also called nonsense reactant or nonsense group (nonsense=dummy)). n is an integer ≧1, typically selected in the interval ≦25, such as ≦10 or ≦5, e.g. 1, 2, 3, 3 or 5. As discussed for the first aspect a linking structure is sufficiently stable to withstand undesired cleavage during the conditions applied when the solid phase is used, for instance during washing steps or steps involving reactions with a reactant, such as an analyte or a reagent.

The molar ratio between the amount of link structures that immobilize affinity reactants 1¹, 1², 1³ . . . 1ⁿ and the sum of the amount of link structures that immobilize affinity reactants 1¹, 1², 1³ . . . 1ⁿ plus the amount of link structure for the nonsense group plus the amount of unaffected RSₛₚ is in the interval ≧0.01, such as ≧0.10 or ≧0.20 or ≧0.40 or ≧0.50 or ≧0.60 or ≧0.70, and/or ≦0.99, such as ≦0.90 or ≦0.80 or ≦0.70 or ≦0.60 or ≦0.50 or ≦0.40 or ≦0.30.

### Immobilization of the Affinity Reactant

Inhibition conditions means that an RSₛₚ solid phase is contacted with a liquid sample containing affinity reactant 1 in a form exhibiting RSₐᵣ₁ and one or more nonsense reactants which each exhibit a structure RSₙₛ that is reactive with RSₛₚ to give the kind of linkage discussed above typically with both of the reactants in excess compared to the amount of RSₛₚ groups. RSₙₛ is typically equal to RSsp. The actual density of affinity reactant 1 in the final solid phase will then be determined by the relation between the rates of the immobilization reaction for affinity reactant 1 and the nonsense reactant(s). In this way it will be simple for the customer to design reaction cavities that differ in wide ranges with respect to amount and density of a desired immobilized affinity reactant. The reaction may be carried out in a batch mode or with the RSₛₚ solid phase in a reaction cavity and reaction under flow conditions.

In an alternative variant the nonsense reactant is reacted with the solid phase before or after affinity reactant 1 has been immobilized. In this variant it is important to secure that only a fraction of RSₛₚ groups are remains unused after the first reaction.

In certain variants one or more additional affinity reactants each of which have a reactive structure RSₐᵣ that is capable of reacting with RSₛₚ as discussed for RSₐᵣ₁ above is reacted in parallel with the solid phase. In other words the liquid used contains an affinity reactant 1¹ with affinity for a first solute, an affinity reactant 1² with affinity for a second analyte, an affinity reactant 1³ with affinity for a third analyte etc up to affinity reactant 1ⁿ (where n is an integer). In the simplest case RS on these additional reactants are equal to RSₐᵣ₁. The final solid phase will contain a plurality of affinity reactants and will be useful when it is desired to have simultaneous interaction between one or more immobilized affinity reactants and one or more dissolved counterparts to these reactants. This kind of solid phase/flow path will be advantageous for assaying two or more analytes in the same liquid sample (multiplexing).

The linkage obtained in the immobilization reaction shall resist undesired cleavage during the intended use of the final flow path. This means that the affinity reactant may be linked to the solid phase covalently or via an affinity bond (e.g. a biospecific affinity bond) or via physical adsorption or by an electrostatic bond etc.

For covalent linking, the RSₐᵣ₁ group is typically selected amongst electrophilic and nucleophilic groups. Examples of groups that may be used are amino groups and other groups comprising substituted or unsubstituted —NH₂, carboxy groups (—COOH/—COO⁻), hydroxy groups, thiol groups, disulfide groups, carbonyl groups (keto, aldehyde), groups containing carbon-carbon double and triple bonds, haloalkyl groups, in particular reactive forms (activated forms) of such groups, e.g. reactive esters, reactive amides or imides, alkene and alkyne groups to which one or more carbonyls are directly attached (α-β unsaturated carbonyls), haloalkyl to which a carbonyl group is directly attacked (α-halo carbonyl) etc. Free radical reactions may also be used for the covalent introduction of binding structures on the solid phase.

Immobilization via affinity bonds utilizes an immobilizing affinity pair. Mobilizing affinity pairs are preferred as RSₛₚ and RSₐᵣ. One member of the pair (immobilized ligand, L=RSₛₚ) is firmly attached to the solid phase material and the other member (immobilizing binder, B=RSₐᵣ) is used as a conjugate (immobilizing conjugate) comprising binder B and the affinity reactant to be immobilized. The pair is typically selected such that it does not interfere with the desired affinity reaction of the affinity reactant to be immobilized and may thus be useful for the immobilization of a range of affinity reactants for which it is non-interfering, i.e. the binder B and the ligand L are both generic. Examples of generic immobilizing affinity pairs are a) biotin-binding compounds such as streptavidin, avidin, neutravidin, anti-biotin antibodies etc and biotin, b) anti-hapten antibodies and the corresponding haptens or antigens, c) IMAC groups (immobilized metal affinity chelates) and an amino acid sequence containing histidyl and/or cysteinyl and/or phosphorylated amino acid residues (i.e. an IMAC motif), d) anti-species specific antibodies and Igs from the corresponding specie(s), e) class/subclass-specific antibodies and Igs from the corresponding class, f) Igs and microbially derived Ig-binding proteins (or vice versa) etc. A fragment or a derivative that exhibits affinity to the same counterpart as the corresponding intact affinity reactant is member of the same pair as the intact pair, i.e. for immunoglobulins the fragment may comprise species- or class/subclass unique Ig parts. Ig means immunoglobulins in mammals and the corresponding proteins in other animals.

The term “conjugate” primarily refers to covalent conjugates, such as chemical conjugates and recombinantly produced conjugates, and comprises at least two moieties bound together typically covalently via a linker. For a recombinant conjugate the linker as well as at least one of the moieties have peptide structure). The term also includes so-called native conjugates, i.e. affinity reactants which each exhibits two binding sites that are spaced apart from each other with affinity directed towards two different molecular entities. Native conjugates thus includes an antigen which has physically separated antigenic determinants that are different, an antibody which comprises a species and/or class-specific determinant in one part of the molecule and an antigen/hapten-binding site in another part.

Preferred immobilizing affinity pairs (L and B) typically have affinity constants (K_{L--B}=[L][B]/[L--B]) that are at most equal to the corresponding affinity constant for streptavidin and biotin, or ≦10¹ times or ≦10² times or ≦10³ times larger than this latter affinity constant. This typically will mean affinity constants that roughly are ≦10⁻¹³ mole/l, ≦10⁻¹² mole/l, ≦10⁻¹¹ mole/l and ≦10⁻¹⁰ mole/l, respectively. The preference is to select L and B amongst biotin-binding compounds and streptavidin-binding compounds, respectively, or vice versa. These affinity constant ranges refer to values obtained by a biosensor (surface plasmon resonance) from Biacore (Uppsala, Sweden), i.e. with the ligand L immobilized to a dextran-coated gold surface.

The capacity of the solid phase for reacting with RSₐᵣ₁ can be measured as the amount of RSₛₚ in mole per unit volume, disregard blocking and destruction of binding sites caused by the immobilization. With this measure suitable binding capacities will typically be found within the interval of 0.001-3000 pmole, such as 0.01-300 pmole, divided by nL solid phase in bed form saturated with liquid. For instance, if 0.1 pmole streptavidin per nL has been immobilized this corresponds 0.4 pmole/nL biotin-binding sites. The conversion factor four is because streptavidin has four binding sites for biotin per streptavidin molecule.

Binding capacity can also be measured as actual binding capacity for RSₐᵣ₁, i.e. mole active RSₐᵣ₁ binding structures per unit volume of the solid phase that contains RSsp (bed form and saturated with liquid such as water). This kind of binding capacity will depend on the immobilization technique, the pore sizes of the solid phase, the size of the entity to be immobilized, the material and design of the solid phase etc. Ideally the same ranges apply for the actual binding capacity as for the total amount of binding sites (as defined above).

Measurements of actual binding capacities can be carried out according to principles well known in the field. This typically means that RSₛₚ of the solid phase is saturated with an excess reagent containing RSₐᵣ₁, whereafter the amount bound to RSₛₚ is measured, for instance directly on the solid phase or after elution. To facilitate measurement labeled forms of reagents may be used, for instance by the use of a mixture of labeled and unlabelled reagent containing RSₐᵣ₁.

All three preceding paragraphs in particular apply if RSₐᵣ₁ together with RSₛₚ define and immobilizing affinity pair as discussed above. The actual binding capacity primarily refers to binding/capturing of the binder B in its basic form, e.g. unconjugated and/or underivatized.

In the case the solid phase is an inner wall of the reaction microcavity, the volume of the solid phase is taken as the volume of the reaction microcavity.

The optimal range of binding capacities (for RSₐᵣ₁) for a particular use depends on a number of factors, e.g. immobilizing pair such as immobilizing affinity pair used, kind of solid phase, e.g. porosity and its base material, size of conjugate if an immobilizing affinity pair is used, etc. Kind of use also include if the use is analytical assay, preparative method, synthetic etc.

A reactive structure RSₛₚ and/or an affinity reactant may be introduced on the solid phase while the solid phase is placed in a reaction cavity of a flow path or in a batch mode while the solid phase is placed outside the flow path. A portion of the RSₛₚ solid phase material is after the introduction of RSₛₚ in a batch mode transferred to a reaction cavity of a flow path where it may be further transformed under inhibition conditions as described herein to exhibit the affinity reactant. The latter transformation may also take place in a batch mode outside the flow path. Alternatively both steps are carried out while the solid phase is placed in a reaction cavity of a flow path. It is sometimes important to have a homogeneous distribution of the immobilized affinity reactant in the flow direction of the solid phase placed in the reaction microcavity or at least to have a sufficient capacity, density, etc of the affinity reactant in the upstream part of the solid phase. Homogeneous distribution can be accomplished by performing both of the steps in a batch mode followed by a transfer of a portion of the solid phase to the flow path.

### The Flow Path

The flow path is preferably part of a microfluidic device, i.e. is a microchannel structure fabricated in a substrate and defined by a system of microconduits comprising functional units that enables all of the steps of an experimental protocol that are to be carried out in the structure to be carried out therein. Typical microfluidic devices have for instance been described by Gyros AB/Amersham Biosciences (WO 99055827, WO 99058245, WO 02074438, WO 02075312, WO 03018198 (US 20030044322) etc); Tecan/Gamera Bioscience (WO 01087487, WO 01087486, WO 00079285, WO 00078455, WO 00069560, WO 98007019, WO 98053311); Åmic AB (WO 03024597, WO 04104585, WO 03101424 etc) etc. In less preferred variants the flow path may be in the form of tubes connecting various functional units such as the reaction cavity, mixing cavity, valve functions etc. In still other variants the flow path is defined by some kind of bibulous material/porous material through which liquid transport can take place by capillary force and the like. The latter variants include various kinds of conventional test strips.

The flow path is typically in the microformat, i.e. has dimensions and/or is capable of handling liquid volumes of the sizes discussed below for microchannel structures/microfluidic devices.

Typical variants of microfluidic devices according to the invention comprise a plurality of flow paths (microchannel structures) and include at least one of the features A-E below.
A) The integer n is equal to 1 in at least two, three or more of the plurality of microchannel structures.
B) The solid phase comprises the above-mentioned dummy group immobilized via a linker structure that derives from reaction of RSₛₚ with RSₙₛ.
C) The combination of affinity reactants 1¹, 1² . . . 1ⁿ (where n is an integer ≦1) are different or equal in at least two of the microchannel structures of a microfluidic device. Affinity reactant 1¹ in each of these at least two microchannel structures is typically equal and the integer n=1, 2, or 3 in at least one, two or more of the at least two microchannel structures.
D) The molar ratio discussed above for one, two or more of the plurality of microchannel structures of a device is equal but different from the corresponding ratio for each of the remaining microchannel structures.
E) The reaction cavity is part of a larger chamber that comprises two or more reaction cavities/solid phases that differ with respect to the number and/or combination of affinity reactants 1¹, 1² . . . 1ⁿ typically with the integer n being equal or different between the solid phases and/or 1, 2, 3 or more for every solid phase. In preferred variants there is a dummy solid phase between every pair of neighbouring solid phases containing an affinity reactant 1¹, 1² . . . 1ⁿ. The different solid phases are layered on top of each other.

The reaction cavity and the solid phase material

The reaction cavity is preferably in the microformat.

The reaction cavity (104a-h) is defined as the part of the flow path (101a-h) where the solid phase carrying an immobilized affinity reactant 1 is present. The upstream/inlet ends of the reaction cavity and of this solid phase thus coincide. In a similar manner the downstream/outlet ends coincide. The reaction cavity may be a part of a larger chamber in which other solid phases may be placed upstream or downstream of the solid phase to which the immobilized affinity reactant 1 is present. These other solid phases may differ from the solid phase containing affinity reactant 1 in being devoid of affinity reactant 1 and/or with respect to kind of solid phase material. Each of these other solid phases may contain one or more other affinity reactants that are capable of interacting with other counterparts and thus define other reaction cavities in the chamber. The same solid phase/reaction cavity may also contain a number of different immobilized affinity reactants. Between two solid phases that differ with respect to kind of immobilized affinity reactant or combination of immobilized affinity reactants there may be a solid phase that is devoid of an affinity reactant, i.e. a dummy solid phase. Other reaction cavities may also be present in separate chambers at other locations of a flow path.

The reaction cavity (104a-h) is typically in the microformat, i.e. has at least one cross-sectional dimension that is ≦1 000 μm, such as ≦500 μm or ≦200 μm (depth and/or width) and is then called microcavity. The smallest cross-sectional dimension is typically ≧5 μm such as ≧25 μm or ≧50 μm. The total volume of the reaction cavity is typically in the nL-range, such as ≦5 000 nL, such as 1 000 nL or ≦500 nL ≦100 nL or ≦50 nL or ≦25 nL.

The reaction cavity typically has a length that is within the range of 1-100 000 μm, such as ≧10 μm or ≧50 μm or 100 μm or ≧400 μm, and/or ≦50 000 μm or ≦10 000 μm or ≦5 000 μm or ≦2 500 μm or ≦1000 μm.

The solid phase may be in the form of porous bed, i.e. a porous monolithic bed or a bed of packed particles that may be porous or non-porous. Alternatively, the solid phase may be an inner wall of a reaction cavity. A monolithic bed may be in the form of a porous membrane or a porous plug.

The term “porous particles” has the same meaning as in WO 02075312 (Gyros AB).

Suitable particles are spherical or spheroidal (beaded), or non-spherical. Appropriate mean diameters for particles are typically found in the interval of 1-100 μm with preference for mean diameters that are ≧5 μm, such as ≧10 μm or ≧15 μm and/or ≦50 μm. Also smaller particles can be used, for instance with mean diameters down to 0.1 μm. Diameters refer to the “hydrodynamic” diameters. Particles to be used may be monodisperse (monosized) or polydisperse (polysized) in the same meaning as in WO 02075312 (Gyros AB).

The base material of a solid phase may be made of inorganic and/or organic material. Typical inorganic materials comprise glass. Typical organic materials comprise organic polymers. Polymeric materials comprise inorganic polymers, such as glass and silicone rubber, and organic polymers of synthetic or biological origin (biopolymers). The term “biopolymer” includes semi-synthetic polymers in which there is a polymer backbone derived from a native biopolymer. Appropriate synthetic organic polymers are typically cross-linked and are often obtained by the polymerisation of monomers comprising polymerisable carbon-carbon double bonds. Examples of suitable monomers are hydroxy alkyl acrylates, for instance 2-hydroxyalkyl acrylates such as 2-hydroxyethyl acrylates, and corresponding methacrylates, acryl amides and methacrylamides, vinyl and styryl ethers, alkene substituted polyhydroxy polymers, styrene, etc. Typical biopolymers in most cases exhibit carbohydrate structure, e.g. agarose, dextran, starch etc.

The term “hydrophilic” in the context of a porous bed contemplates a sufficient wettability of the surfaces of the pores for water to be spread by capillarity all throughout the bed when one end of the bed is in contact with excess water (absorption). The expression also means that the inner surfaces of the bed that is in contact with an aqueous liquid medium during step (ii) shall expose a plurality of polar functional groups which each has a heteroatom selected amongst oxygen and nitrogen, for instance. Appropriate functional groups can be selected amongst hydroxy groups, ethylene oxide groups (—X—[CH₂CH₂O—]ₙ where n is an integer >1 and X is nitrogen or oxygen), amino groups, amide groups, ester groups, carboxy groups, sulphone groups etc. For solid phase materials in particle form this means that at least the outer surfaces of the particles have to exhibit polar functional groups. Similar material, wettabilities and functional groups etc also apply to solid phases in the form of inner walls.

### Flow Conditions During the Immobilization of the Affinity Reactant

The affinity reactant that exhibits RSₐᵣ₁ is presented to RSₛₚ on the solid phase while the liquid in which the affinity reactant is present is passing the reaction cavity/solid phase under continuous flow conditions or during alternating flow and static conditions. The flow rate used may provide non-diffusion limiting conditions for the reaction even if also diffusion-limiting conditions may also be used.

The appropriate flow rate through the porous bed may depend on a number of factors:
a) affinity reactant to be immobilized;
b) the dimensions of the reaction cavity (volume, length etc),
c) the kind of solid phase (the solid phase material, porosity, bed or coated inner wall etc); and
d) etc.

Typically the transport conditions through the reaction cavity should give a residence time of ≧0.010 seconds such as ≧0.050 sec or ≧0.1 sec for the liquid aliquot containing the RSₐᵣ₁ affinity reactant. The upper limit for the residence time of the aliquot in the reaction cavity/solid phase is typically below 2 hours such as below 1 hour. Illustrative flow rates are within 0.001-10,000 nl/sec, such as 0.01-1,000 nl/sec or 0.01-100 nL/sec or 0.1-10 nL/sec. These flow rate intervals may primarily be useful for solid phase volumes in the range of 1-1,000 nL, such as 1-200 nL or 1-50 nL or 1-25 nL. Residence time refers to the time it takes for a liquid aliquot to pass the solid phase in the reaction cavity. Optimization typically will require experimental testing for each particular system.

The liquid flow through the solid phase can be driven by in principle any kind of forces, e.g. by electrokinetically or non-electrokinetically created forces with preference for centrifugal force possibly combined with capillary force for flow paths in microfluidic devices adapted for this. See further below.

### Microfluidic Devices

A microfluidic device is a device that comprises one, two or more microchannel structures (101a-h) in which one or more liquid aliquots/samples, e.g. liquid sample 1 and/or 2, that have volumes in the μL-range, typically in the nanolitre (nL) range, and contains various kinds of reactants, such as analytes and reagents, products, samples, buffers and/or the like are processed. Each microchannel structure (101a-h) comprises all the functional parts needed for performing the steps of the innovative assay that are to be performed within the microfluidic device. The μL-range contemplates volumes ≦1 000 μL, such as ≦100 μL or ≦10 μL and includes the nL-range that has an upper end of 5,000 nL but in most cases relates to volumes ≦1,000 nL, such as ≦500 nL or ≦100 nL. The nL-range includes the picolitre (pL) range. A microchannel structure comprises one or more cavities and/or conduits that have a cross-sectional dimension that is ≦10³ μm, preferably ≦5×10² μm, such as ≦10² μm.

A microchannel structure (101a-h) thus may comprise one, two, three or more functional units selected among: a) inlet arrangements (102,103a-h) comprising for instance an inlet port/inlet opening (105a-b,107a-h), possibly together with a volume-metering unit (106a-h,108a-h) (for metering liquid aliquots to be processed within the device), b) microconduits for liquid transport, c) reaction microcavities (104a-h); d) mixing microcavities/units; e) units for separating particulate matters from liquids (may be present in the inlet arrangement), f) units for separating dissolved or suspended components in the sample from each other, for instance by capillary electrophoresis, chromatography and the like; g) detection microcavities; h) waste conduits/microcavities (112,115a-h); i) valves (109a-h,110a-h); j) vents (116a-i) to ambient atmosphere; liquid splits (liquid routers) etc. A functional unit may have several functionalities, e.g. a reaction microcavity (104a-h) and a detection microcavity may coincide. Various kinds of functional units in microfluidic devices have been described by Gyros AB/Amersham Pharmacia Biotech AB: WO 99055827, WO 99058245, WO 02074438, WO 02075312, WO 03018198 (US 20030044322), WO 03034598, WO 05032999 (U.S. Ser. No. 10/957,452), WO 04103890, WO 2005094976 and by Tecan/Gamera Biosciences: WO 01087487, WO 01087486, WO 00079285, WO 00078455, WO 00069560, WO 98007019, WO 98053311. In advantageous forms a reaction microcavity (104a-h) intended for a hydrophilic porous bed is connected to one or more inlet arrangements (upstream direction) (102,103a-h), each of which comprises an inlet port (105a-b,107a-h) and at least one volume-metering unit (106a-h,108a-h). One advantageous variant of inlet arrangement (103a-h) is only connected to one microchannel structure (101a-h) and/or reaction microcavity (104a-h) intended to contain the solid phase material. Another advantageous inlet arrangement (102) is common to all or a subset (100) of microchannel structures (101a-h) and/or reaction microcavities (104a-h) intended to contain the solid phase material. This latter variant comprises a common inlet port (105a-b) and a distribution manifold with one volume-metering unit (106a-h) for each microchannel structure/reaction microcavity (101a-h/104a-h) of the subset (100). In both variants, each of the volume-metering units (106a-h,108a-h) in turn is communicating with downstream parts of its microchannel structure (101a-h), e.g. the reaction microcavity (104a-h). Microchannel structures linked together by a common inlet arrangement (102) and/or common distribution manifold define a group or subset (100) of microchannel structures. Each volume-metering unit (106a-h,108a-h) typically has a valve (109a-h,110a-h) at its outlet end. This valve is typically passive, for instance utilizing a change in chemical surface characteristics at the outlet end, such as a boundary between a hydrophilic and hydrophobic surface (hydrophobic surface break) (WO 99058245, WO 2004103890, WO 2004103891 and U.S. Ser. No. 10/849,321 (Amersham Pharmacia Biotech AB and Gyros AB)) and/or in geometric/physical surface characteristics (WO 98007019 (Gamera)).

Typical inlet arrangements with inlet ports, volume-metering units, distribution manifolds, valves etc have been presented in WO 02074438, WO 02075312, WO 02075775 and WO 02075776 (all Gyros AB).

Each microchannel structure has at least one inlet opening (105a-b,107a-h) for liquids and at least one outlet opening for excess of air (vents) (116a-i,112) and possibly also for liquids (circles in the waste channel (112)).

The microfludic device contains a plurality of microchannel structures per device where one or more, such as all, of the structures are intended to contain the solid phase according to the invention. Plurality in this context means two, three or more microchannel structures and typically is ≧10, e.g. ≧25 or ≧90 or ≧180 or ≧270 or ≧360.

Different principles may be utilized for transporting the liquid within the microfluidic device/microchannel structures between two or more of the functional units. Inertia force may be used, for instance by spinning the disc as discussed in the subsequent paragraph. Other useful forces are capillary forces, electrokinetic forces, non-electrokinetic forces such as capillary forces, hydrostatic pressure etc.

The microfluidic device typically is in the form of a disc. The preferred formats have an axis of symmetry (Cₙ) that is perpendicular to or coincides with the disc plane, where n is an integer ≧2, 3, 4 or 5, preferably □ (C_{∞}). In other words the disc may be rectangular, such as square-shaped and other polygonal forms but is preferably circular. Spinning the device around a spin axis that typically is perpendicular or parallel to the disc plane may create the necessary centrifugal force. Variants in which the spin axis is not perpendicular to a disc plane are given in WO 04050247 (Gyros AB).

If centrifugal force is used for driving liquid flow through the reaction microcavity/solid phase, the reaction microcavity is typically oriented with the flow direction essentially radially outwards from the spin axis.

The preferred devices are typically disc-shaped with sizes and/or forms similar to the conventional CD-format, e.g. sizes that are in the interval from 10% up to 300% of a circular disc with the conventional CD-diameter (12 cm).

Microchannels/microcavities of a microfluidic device may be manufactured from an essentially planar substrate surface that exhibits the channels/cavities in uncovered form. In a subsequent step channels/cavities are covered by another essentially planar substrate (lid). See WO 91016966 (Pharmacia Biotech AB) and WO 01054810 (Gyros AB). Both substrates are preferably fabricated from plastic material, e.g. plastic polymeric material.

The fouling activity and hydrophilicity of inner surfaces should be balanced in relation to the application. See for instance WO 0147637 (Gyros AB).

The terms “wettable” (hydrophilic) and “non-wettable” (hydrophobic) of inner surfaces in a microchannel structure contemplate that a surface has a water contact angle ≦90° or ≧90°, respectively. In order to facilitate efficient transport of a liquid between different functional parts, inner surfaces of the individual parts should primarily be wettable, preferably with a contact angle ≦60° such as ≦50° or ≦40° or ≦30° or ≦20°. These wettability values apply for at least one, two, three or four of the inner walls of a microconduit. In the case one or more of the inner walls have a higher water contact angle, for instance is hydrophobic, this can be compensated for by a more wettable surfaces of one or more of the other inner wall(s). The wettability, in particular in inlet arrangements should be adapted such that an aqueous liquid to be used will be able to fill up an intended microcavity/microconduit by capillarity (self suction) once the liquid has started to enter the cavity/microconduit. A hydrophilic inner surface in a microchannel structure may comprise one or more local hydrophobic surface breaks in a hydrophilic inner wall, for instance for introducing a passive valve, an anti-wicking means, a vent solely function as a vent to ambient atmosphere etc (rectangles in FIG. 1). See for instance WO 99058245, WO 02074438, US 20040202579, WO 2004105890, WO 2004103891 (all Gyros AB).

Contact angles refer to values at the temperature of use, typically +25° C., are static and can be measured by the method illustrated in WO 00056808 and WO 01047637 (all Gyros AB).

### Affinity Reactants

The affinity reactants referred to in the context of the invention typically are selected among members of ligand-receptor pairs, such as a) antigens/haptens, b) antibodies or antigen/hapten-binding fragments thereof including affinity reactants mimicking the antigen/hapten-binding ability of antibodies and their antigen/hapten-binding fragments, c) nucleic acids including single and double stranded forms, and polynucleotides and oligonucleotides and mimetics of nucleic acids, and d) components of catalytic systems, such as biocatalytic systems like enzymatic systems.

Components of catalytic systems are cocatalysts, catalysts as such, cofactors, substrates, cosubstrates, inhibitors, activators, effectors etc that for enzymatic systems correspond to coenzymes, enzymes as such, cofactors, substrates, cosubstrates, inhibitors, activators, effectors etc.

Other receptor-ligand pairs are hormone-hormone receptor pairs. A hormone may exhibit steroid structure or peptide structure.

An affinity reactant used in the context of the invention typically exhibits one or more structures selected among:
a) amino acid structures including protein structures such as peptide structures such as poly and oligopeptide structures, and including mimetics and chemically modified forms of these structures etc;
b) carbohydrate structures, including mimetics and chemically modified forms of these structures, etc;
c) nucleotide structures including nucleic acid structures, and mimetics and chemically modified variants of these nucleotide structures, etc;
d) lipid structures such as steroid structures, triglyceride structures, etc, and including mimetics and chemically modified forms of these structures;
e) other structures of organic or bio-organic nature

A number of other structures and substances may also be present in the affinity reactants used. Such other structures and substances can be illustrated with haptenic/antigenic structures of infectious agents (bacteria, algae, fungi, viruses, prions, moulds, parasites etc), drugs, autoantigens, allergens, synthetic or native immunogens that are capable of provoking humoral immune responses used for diagnostic purposes or for the manufacture of an antigen specific antibody reagent or drug.

### Uses of the Flow Paths

The innovative flow path may be used for carrying out processes in which an affinity counterpart to an immobilized affinity reactant and present in a liquid that is to pass through the reaction cavity that contains the solid phase is allowed to interact with the immobilized affinity reactant. The counterpart may be in dissolved form including also suspended forms, such as suspended cells, viruses, bacteriophages and their suspended fragments. In preferred variants the interaction is taking place while the liquid is flowing through the reaction microcavity preferably during continuous flow as outlined for immobilization of the affinity reactant according to the invention, i.e. a liquid sample containing the counterpart is provided at an inlet end of the reaction microcavity and then permitted to flow through the cavity while interacting with the immobilized affinity reactant. Interacting in this context typically contemplates capturing to the solid phase including more transient variants such as when a substrate is converted to a product by a catalytic system that comprises a component that is used as the immobilized affinity reactant. The interacting step may be part of an assay for determining or characterizing an analyte in a liquid sample. Thus the use may be selected among classical affinity assays, such as nucleic acid hybridisation assays, immunoassays, and enzyme assays. The assay protocol may be an inhibition assay or a non-inhibition assay. Typical non-inhibition assays include so-called sandwich assays. The assays may utilize detectable reagents that may or may not be immobilized to the solid phase and used for measuring the interaction of the analyte (e.g. equal to or a counterpart to the immobilized affinity reactant) with the immobilized affinity reactant. The detectable reactant may for instance be the immobilized affinity reactant or a dissolved reactant such as affinity reactant 2 used in the bridging method described in our international application “Bridging Method” filed in parallel with this application.

The innovative flow path may comprise several immobilized affinity reactants 1¹, 1² . . . 1ⁿ. as discussed above. Such variants are well fitted for multiplexing within the flow path, for instance by parallel assaying of a plurality of analytes that are present in a liquid sample. The analytes may for instance be counterparts to the immobilized affinity reactant 1¹, 1² . . . 1ⁿ. In multiplexing according to the invention, the interaction of each analyte with its counterpart, e.g. an immobilized counterpart that is immobilized according to the present invention, is measured by the use of a detectable affinity reactant that preferably is different or not different from the detectable reactant used for the other analytes. The difference is typical with respect to at least one of a) specificity in reaction with the various analytes, and b) the physical location at which the reactant is detected/measured, and/or c) detectability such as kind of radiation emitted, reflected or absorbed from the reactant. With respect to the innovative flow path one can envisage that it should be advantageous if the interaction between each analyte or combination of analytes and the corresponding immobilized affinity reactant or the corresponding combination of affinity reactants, takes place at physically separated parts or zones of a chamber where each zone/part contains a solid phase with an immobilized affinity reactant or a combination of such reactants.

### EXPERIMENTAL PART

### Assay Procedure

The invention was investigated in two model systems:
a) anti-PPV antibody as analyte and solid phase bound PPV) as affinity reactant 1 (antigen and labelled PPV as affinity reactant 2 (antigen), and
b) anti-IgG monoclonal antibody as analyte, solid phase bound IgG as affinity reactant 1 (antigen), and labelled IgG as detectable affinity reactant 2 (antigen).

PPV stands for Porcine Parvovirus. The main steps of the assay as used in the experimental part step 1) Capture reagent addition=addition of biotinylated PPV-antigen or biotinylated IgG in combination with biotinylated bovine serum albumin (BSA), step 2) Analyte addition/Capturing step=addition of sample containing analyte (anti-PPV antibody or anti IgG antibody); and step 3) Measuring/Detection step=addition of fluorophor labelled PPV antigen or fluorophor labelled IgG. The particular assay protocol selected is called Bioaffy 1C v2 and its detailed is given at the end of the experimental part.

The abbreviation “PPV” refers to an antigen preparation from porcine parvovirus.

### Microfluidic Device and Instrumentation

The microfluidic device was the same as the one shown WO 04083108 (Gyros AB) and WO 04083109 (Gyros AB). The solid phase was polystyrene particles coated with phenyldextran to which streptavidin had been immobilized and packed to a bed/column in the reaction microcavity (104). The instrument used for processing was a Gyrolab Workstation equipped with laser fluorescence detector and the microfluidic disc a Bioaffy CD microlaboratory, both being products of Gyros AB, Uppsala, Sweden.

### Example 1

### Assay of Anti-PPV Antibody

Analytes: Rabbit polyclonal anti-PPV antiserum and a mouse anti-PPV IgG monoclonal from National Veterinary Institute, Uppsala, Sweden. Mouse anti-PPV IgG monolonal from Svanova, Sweden (Svanovir™: ELISA test for the detection of PPV antibodies in serum, Manual number 19-7400-00/04). Serum samples collected from mice during various stages of immunization with PPV antigen. Standards were pooled sera from mice during immunization with PPV diluted in steps of 5 (1/5 to 1/78125).

Reagents PPV and bovine serum albumin (BSA). PPV was obtained from Rivera, E at the National Veterinary Institute, Uppsala, Sweden (Rivera E et al., “The Rb1 fraction from ginseng elicits Th1 immunity” Vaccine (in press)). Pool II of the preparation was used.

### Biotinylated Reagents (PPV=Affinity Reactant 1, BSA)

50 μg of PPV was used. In order to obtain a concentration of 1 mg/mL, 500 μL of the virus fraction was centrifuged in a Nanosep 30K filter from Pall Corporations. EZ-Link-Sulfo-NHS-LC-Biotin (Pierce) was diluted to 10 mM and used in 20 times molar excess. The solutions were mixed and incubated in room temperature for 40 minutes. Free biotin was removed by placing a volume of 450 μL PBS (0.015M NaPO₄ pH 7.4, 0.15M NaCl, 0.02% NaN₃) together with the reaction mixture on the membrane of a Nano Sep 30K column followed by centrifugation at 13,000 rpm until about 50 μL remained. To be sure that free biotin was removed another wash with 450 μl PBS was performed. The final volume was 60 μl.
Essentially the same procedure was used for biotinylation of bovine serum albumin (BSA). The starting concentration was 1 mg BSA per mL in a volume of 300 μL. The biotin reagent was used in twelve time's molar excess. The purification step was performed using protein desalting spin columns from Pierce. The final volume was 330 μl.

### Fluorophor Labeled PPV (Affinity Reactant 2)

90 μg the virus preparation was concentrated to 1 mg/mL using Nanosep 30K filter from Pall Corporations and labeled with Alexa fluorophor 647 monoclonal antibody labelling kit (A-20186, Molecular Probe) according the manufactuer's instruction. The final product had a volume of 90 μL.

Titration of immobilized biotinylated reactants (immobilized PPV=affinity reactant 1) In order for PPV to bind to antibodies in a detectable manner, biotinylated PPV together with biotinylated Bovine Serum Albumin (BSA) was immobilized on the solid phase. A suitable combination of concentrations had to be established so that the antibody would be able to bind both the biotinylated and the labeled reagents i.e. “bridging” the two antigen preparations. In a conventional antibody assay this measure would not be needed as long as the column is saturated with antigen. However, in the assay according to the invention the antibody is not allowed to bind with both arms to the immobilized antigen (affinity reactant 1) since this would prevent binding to the detecting antigen (affinity reactant 2). On the other hand, there must be enough antigen (affinity reactant 1) immobilized on the solid phase to generate a response, or the assay is not useful. If the reaction equilibrium between antigen and antibody were shifted too much to either side, it would in theory be impossible to obtain a signal.

Different 1:1 combinations of diluted/undiluted stock solutions of biotinylated PPV (dilutions 1/10-1/1280) and biotinylated BSA (dilutions 1-1/128) in PBS-T were tested. The purpose of using BSA together with PPV is to fully saturate the streptavidin column with protein and thus, avoid unspecific surface interactions between labeled PPV and the solid phase including its pre-immobilized streptavidin.

To promote bridge binding, a mixture of biotinylated BSA and biotinylated PPV were added in the capture reagent addition step. The signal ratio between blank and sample was calculated. A large ratio between sample and background response is desired for an assay with high performance. The results suggested a dilution for PPV in the interval of 80-160 times and for BSA a dilution in the interval of 16-64 times.

To study the titrations in more detail, diagrams of the viewer (Software program in the instrument used) were compared and evaluated. It could be observed that more PPV on the column led to a greater signal and to an enrichment of the analyte at the top of the column. The absolute response values revealed a turning point at a dilution of 1/80 for 1/64 biotinylated BSA. The viewer showed that more biotinylated BSA gave the peak a broader base and the profile appears to be collapsing. Column profiles with peaks at the top of the column were favored for the algorithm to integrate as much of the signal as possible.

It could be concluded that the ratio between BSA and PPV should be about 1.57. In the interest of saving reagents, the chosen dilutions were 1/100 for PPV and 1/64 for BSA mixed together as 1:1. This was later modified to 1/80 for PPV and 1/51 for the BSA preparation.

### Titration of Fluorophor Labeled PPV (Affinity Reactant 2)

The optimal concentration for fluorophor labeled reactant was also tested by using the stock solution of fluorophor labeled PPV in three different dilutions, 1/10, 1/20 and 1/40 in PBS with 1% BSA. Rabbit anti-PPV serum was serially diluted and used as a reference sample to generate data points for all titrations. It was found that the dilution 1/40 gave the lowest background. This dilution was consequently used.

### Performance

Precision: The mouse serum was diluted 125 times in PBS with 1% BSA and aspirated in twelve repeats and assyed. The coefficient of variance (CV) was 1.89%.

Measuring range: See FIG. 2.

Reproducibility: See FIG. 3.

### Sample Dilution

To evaluate possible dilution factors for serum samples, two mice from with low titers of anti-PPV, two mice with intermediate titers of anti-PPV and two mice with high titers of anti-PPV were selected. All samples were taken two weeks after immunization. The samples were diluted as 1/2, 1/4, 1/8, 1/16 and 1/32 and run in triplicates. The samples were analyzed at different dilutions without any technical difficulties. The least diluted samples could be measured for all mice and could be distinguished from the background signal.

### Gel Filtration

In order to prove that the bridging assay is independent of immunoglobulin class, a gel filtration experiment was performed. Sera was taken at two occasions from five mice during PPV immunization and pooled to 100 μl: a) two weeks after immunization (2vI) where IgM could be expected and b) five weeks after booster (5vII) where mostly IgG is present. The pools were separately chromatographed on Superdex™ (ÄKTA FPLC™) by first washing the column three times with milliQ water followed by two equilibrations with degassed PBS whereafter the serum sample was injected. Fractions were collected in microtiter wells. Every second fraction within the detection range was tested in the inventive assay method on Bioaffy™ CD microlaboratory.

Activity was found at two distinct peaks for the pool obtained two weeks after immunization. The lower activity peak was close to the void volume while the higher activity peak was close to the albumin retention volume. Hence, the molecular size of the analyte varied widely and it seemed likely that PPV specific IgM contributed to the low activity peak and PPV specific IgG to the high activity peak. For the sample taken five weeks after booster only one activity peak could be seen. This peak was mapped to the area in the chromatogram where IgG would be expected.

Quantification of unknown samples. A total of 234 sera from mice during immunization with PPV were run in triplicates at a normal dilution of 1/25. This dilution proved to be insufficient for samples with high anti-PPV antibody titers for which saturated columns were found. Samples displaying saturated columns were rerun at higher dilutions.

### Example 2

### Assay of Anti-IgG Antibody

Analytes: One polyclonal antibody from Sigma (prod. nr 555784) and three monoclonal antibodies specific for human IgG were used as analytes, where BD Pharmingen supplied one clone (19885) and Fitzgerald supplied the remaining two clones (10-I21 and 10-I17). The monoclonals are called 1561, 1523 and 1560 in FIG. 4a-c.

### Reagents

Human monoclonal IgG1λ from a myeloma (Sigma) was used as antigen (hIgG)
hIgG was labeled with biotin in the same manner as described above for PPV. For the biotin reaction, the first step was to exchange buffers since Tris in the storage buffer could interfere with the biotin reagent. Nanosep 30K filters from Pall Corporations were used for this purpose. After removal of Tris, EZ-Link-Sulfo-NHS-LC-Biotin (Pierce) was diluted to 10 mM and added in 12 times molar excess to 100 μL of hIgG solution. The solutions were mixed and incubated in room temperature for 1 h. Absorbance at 280 nm was measure and the protein concentration was determined to 3.45 μM. Biotinylated hIgG=affinity reactant 1)
Fluorophor labeling was carried out as described for PPV above. The starting amount of hIgG was 100 μg. The degree of labeling was determined by measuring absorbance at 280 nm and at 650 nm to about 7 moles ALEXA (fluorophor) per mole protein with a final concentration of 2.76 μM. Fluorophor labeled hIgG=affinity reactant 2.

### Titrations of Reagents

The biotinylated reagents (hIgG and BSA) were titrated to find the optimal dilutions for the assay system before different monoclonal antibodies were tested as analytes. The procedure was essentially the same procedure as for PPV, with different dilutions of the stock solutions of biotinylated hIgG mixed in a 1:1 ratio with biotinylated BSA. The response ratio between signal and blank together with the column profiles formed the basis for the final selection of the most favorable combination. The combination 1/100 of biotinylated hIgG and 1/64 of biotinylated BSA was chosen.

Dilutions of the detecting antigen (fluorophor labeled hIgG) were also tested to obtain a large signal to noise ratio. Fluorophor-labeled hIgG was run with dilutions factors of 20, 40 and 80. A dilution factor of 40 was selected.

For all titration experiments a polyclonal antibody was used as analyte reference.

### Different Amounts of Biotinylated Antigen

Three monoclonal mouse anti-human IgGs were tested with a combination of biotinylated hIgG (B*hIgG) together with biotinylated BSA in a 1:1 ratio (see below).

| | |
|---|---|
| ¼ B*hIgG | with 1/64 B*BSA |
| 1/20 B*hIgG | with 1/64 B*BSA |
| 1/100 B*hIgG | with 1/64 B*BSA |
| 1/500 B*hIgG | with 1/16 B*BSA |

To ensure that the streptavidin column is saturated with protein and to avoid unspecific interactions, a dilution of 1/16 BSA was used with the most diluted biotinylated IgG. The monoclonal anti-hIgG antibodies (analytes) were separately run with concentrations ranging from 5000 ng/mL down to 8 ng/mL generating curves from five data points. Detection was done with 69 nM fluorophor labeled hIgG.

The column profiles studied in Gyrolab viewer show higher response levels with more antigen (hIgG) in the capture reagent mixture than when less antigen is added to the column. The peaks of all three antibodies seem to collapse when less biotinylated antigen is present and there is a tendency for more plateau-like peaks as well. It actually seemed to be possible that by including less antigen in the capture reagent, antibodies with low affinity to the antigen will fade away and eventually approach blank levels. This possibility is also supported by the standard curves obtained for the three monoclonal anti-IgG antibodies used as analytes. See FIG. 4a-c.

The assay protocol used (Bioaffy 1C 2v) comprises the steps:
Initial needle wash: Particle wash 1, Particle wash spin 1, Particle wash 2, and Particle wash spin 2
Capture reagent addition: Capture reagent spin, Capture reagent wash 1, Capture reagent wash spin 1, Capture reagent wash 2, Capture reagent wash spin 2
Analyte addition: Analyte spin, Analyte wash 1, Analyte wash spin 1, Analyte wash 2, and Analyte wash spin 2
CD alignment 1: Detect background PMT 1%, Detect background PMT 5% and Detect background PMT 25%, Spin out, Detection reagent addition, Detection reagent spin, Detection reagent wash 1, Detection reagent wash spin 1, Detection reagent wash 2, Detection reagent wash spin 2, Detection reagent wash 3, Detection reagent wash spin 3, Detection reagent wash 4, Detection reagent wash spin 4
CD alignment 2: Detect PMT 1%, Detect PMT 5%, Detect PMT 25%

### Example 3

### Assay of Heterophilic Antibodies

This assay was designed after that significant positive assay responses had unexpectedly been found in several serum and plasma samples (citrate plasma, heparin plasma, EDTA plasma) by a sandwich hTNFα assay utilizing R-1530 mouse anti-hTNFα antibody as capture antibody and another mouse anti-hTNFα antibody as detector antibody.

Microfluidic device and instrumentation: The same as for examples 1 and 2.

Assay procedure: As outlined for examples 1 and 2.

Samples: Sera from 16 blood donors. The sera were thawed in refrigerator during night, vortexed and finally centrifuged for 15 min at 4000 rpm in Eppendorf centrifuge at +8° C.

### Buffers

PBS-T: 15 mM PBS pH 7.4, Tween™ 0.05%, NaN₃ 0.02%

PBS-BSA: 15 mM PBS pH 7.4, NaN₃.0.02%, 1% BSA

### Reagents:

| Capture Ab¹⁾ (affinity reactant 1) | Detecting Ab²⁾ (affinity reactant 2) |
|---|---|
| R-1530 mouse anti-hTNFα | F-1197 mouse anti-hTNFα (IgG1) |
| 0.1 mg/mL³⁾ | 25 nM³⁾ |
| | F-1181 goat anti-hIL-1β (polyclonal) |
| | 50 nM³⁾ |
| | F-1210 rat anti-hIL-5 (IgG2A) |
| | 50 nM³⁾ |
| | F-1155 mouse anti-hTNFβ (IgG1) |
| | 50 nM³⁾ |

¹⁾Biotinylated as outlined for hIgG in example 2
²⁾Labelled with Alexa 647 as outlined for hIgG in example 2.
³⁾Concentrations of solutions introduced into the microfluidic device

### Reference Standard:

Recombinant hTNFα in the interval 2.4-1750 pg/mL in PBS-BSA.

### Results:

Significantly elevated levels of heterophilic antibodies could be measured in several of the serum samples. In principle the same relative variation could be obtained for each detecting antibody and for EDTA-, heparin- and citrate-plasma corresponding to the blood donor sera.

Certain innovative aspects of the invention are defined in more detail in the appending claims. Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A flow path comprising a reaction cavity in which there is a solid phase to which an affinity reactant 1¹ has been immobilized by the use of an immobilizing pair of reactive structures that comprises
a) a plurality of functional equal reactive structures RSsp on the solid phase, and
b) a reactive structure RSar1 on affinity reactant 1¹, where RSsp and RSar1 are mutually reactive with each other to the formation of a link structure that immobilizes affinity reactant 1¹ to the solid phase, characterized in that the solid phase comprises a plurality of structures that derive from RSsp but do not immobilize affinity reactant 1¹ to the solid phase.

2. The flow path of claim 1, characterized in that the immobilizing pair of reactive structures RSsp and RSar1 is selected among biotin-binding compounds, such as streptavidin/avidin/neutravidin and anti-biotin antibody, and biotinylated affinity reactants (or vice versa),

3. The flow path of claim 1, characterized in that the plurality of structures that do not link to affinity reactant 1¹ comprises a) one portion that links to one or more additional affinity reactants 1², 1³ . . . 1 (where n is an integer ≧1), and/or b) a second portion that links to a nonsense group, and/or c) a third portion that is equal to RSsp

4. The flow path of claim 1, characterized in that the molar ratio between the amount of link structures that immobilize affinity reactants 1¹, 1², 1³ . . . 1ⁿ and the sum of the amount of link structures that immobilize affinity reactants 1¹, 1², 1³ . . . 1ⁿ plus the amount of link structure for the nonsense group plus the amount of RSsp is in the interval ≧0.01 and/or ≦0.99.

5. The flow path of claim 1, characterized in that it is a microchannel structure of a microfluidic device.

6. The flow path of claim 5, characterized in that the microfluidic device comprises a plurality of said microchannel structure with n=1 in at least two of said plurality of microchannel structures.

7. The flow path of claim 6, characterized in that the combination of affinity reactants 1¹, 1² . . . 1ⁿ (where n is an integer ≧1) are different or equal in at least two of said plurality of microchannel structures with affinity reactant 1¹ in each of said at least two microchannel structures being equal and with n=1, 2, or 3 in at least one of said at least two microchannel structures.

8. The flow path of claim 6 in combination with the flow path of claim 4, characterized in that said ratio for one, two or more of said plurality of microchannel structures are equal but different compared to the corresponding ratio for the remaining ones of said plurality of microchannel structures.

9. The flow path of claim 1, characterized in that the reaction cavity is part of a larger chamber that comprises two or more reaction cavities/solid phases that differ with respect to the number and/or combination of affinity reactants 1¹, 1² . . . 1ⁿ with the integer n being equal or different for the solid phases and/or 1, 2, 3 or more for every solid phase.

10. The flow path of claim 9, characterized in that that there is a dummy solid phase between a pair of neighboring solid phases containing an affinity reactant 1.

11. The flow path of claim 1, characterized in that affinity reactants 1¹, 1² . . . 1ⁿ (where n is an integer ≧1) are selected among a) antigens/haptens, b) antibodies or antigen/hapten-binding fragments thereof including affinity reactants mimicking the antigen/hapten-binding ability of antibodies and their antigen/hapten-binding fragments, c) nucleic acids including single and double stranded forms, and polynucleotides and oligonucleotides and mimetics of nucleic acids, and d) components of catalytic systems.
